(19) United States
(12) Patent Application Publication
(10) Pub. No.: US 2010/0001476 A1
(43) Pub. Date: Jan. 7, 2010

(54) Device for Sealing of Inserted Cables, Conduits or Pipes

(76) Inventor: Jan Bröder, Pinneberg (DE)

Correspondence Address: HARNESS, DICKEY & PIERCE, P.L.C., P.O. BOX 8910, RESTON, VA, 20195, US

(21) Appl. No.: 12/086,878

(22) PCT Filed: Dec. 19, 2006
(86) PCT No.: PCT/SE2006/050595

§ 371 Date: Apr. 13, 2009

(30) Foreign Application Priority Data
Dec. 21, 2005 (DE) 10 2005 062 655.6

(51) Int. Cl. F16L 5/02

(52) U.S. Cl. 277/606

(57) ABSTRACT

A device for sealing of conduits inserted in circular lead-throughs of walls and roofs designed as a frame is provided for the arrangement of a plug formed sealing body of elastic material which forms a quadrangular pack accommodation. In the pack accommodation elastic splitted modules in square form are inserted with received conduits and arranged sealingly by clamping elements acting on the sealing body. To increase the pack accommodation for an assembly and disassembly of the modules it is so provided, that at least one boundary side of the pack accommodation forms a free space for receiving an insertable part element after assembly of the modules. The part element forms a part of the sealing body and is designed as horizontal segment of a part of the depth of the sealing body.

The invention concerns a device for sealing of inserted cables, conduits or pipes in circular lead-throughs for walls and roofs formed as frames with an inserted, plug formed sealing body of elastic material and forming a quadrangular pack accommodation for wholly or partially elastic modules arranged between the cables, conduits or pipes as splitted fitting pieces in square form in a modular arrangement above and/or adjacent to each other, which modules by means of pressure elements and displaceable clamping elements and by means of the sealing body in the plane of the frame clamp the received elements sealingly in the frame.

Devices of this kind are known in numerous designs. In DE GM 88 09 629 U1 a sealing for cable lead-throughs for circular frames of wall lead-throughs is shown. Wherein a plug formed sealing body of elastically workable material and having a quadrangular accommodation space for provided insertable splitted fitting pieces is arranged for receiving cables and the like, which are possible to sealingly clamp by means of clamping elements acting on the sealing body, in order to achieve a tightness against fire, water and gas. The deficiency of devices of this kind lies therein, that it is only laboriously possible to get the parting lines of the separate modules as a column at the assembly in the allowed accommodation space, especially at an assembly of the last module row. Also a change or a disassembly of the modules causes difficulties.

The object of the invention is to improve a device of this kind and in a simple way give an expansion of the assembly volume as well as with retention of a necessary clamping force for sealing make an assembly simplification possible.

The solution to this object according to the invention is that at least one boundary surface of the pack accommodation for the modules is formed by a separate part element, which is designed as segment of the sealing body and over a part of the depth of the sealing body, whereby the part element forms a free space for assembly for insertion of the modules and may be positioned in the sealing body for end assembly by means of the clamping elements.

Assembly and disassembly is hereby simplified, whereby it is possible to handle the modules in a larger assembly volume and to guarantee necessary tightness.

An advantageous design is accomplished in that the part element of the sealing body is formed above or under above each other arranged parting lines of the modules.

To give a sufficient assembly space, it is suggested that the separate part element has about 60% of the depth of the sealing body.

To facilitate assembly of the part element it is so arranged, that in the end region of the boundary surface of the pack accommodation the part element has a bevelling in the insert direction.

It is further suggested, that the fixed part of the sealing body corresponding with the part element has a bevelling in the insertion direction of the modules.

In a further development the device is arranged in such a way, that a horizontal partition line between sealing body and part element has a gradient in the insertion direction of the part element.

In the drawings one embodiment of the invention is represented. In the drawings:

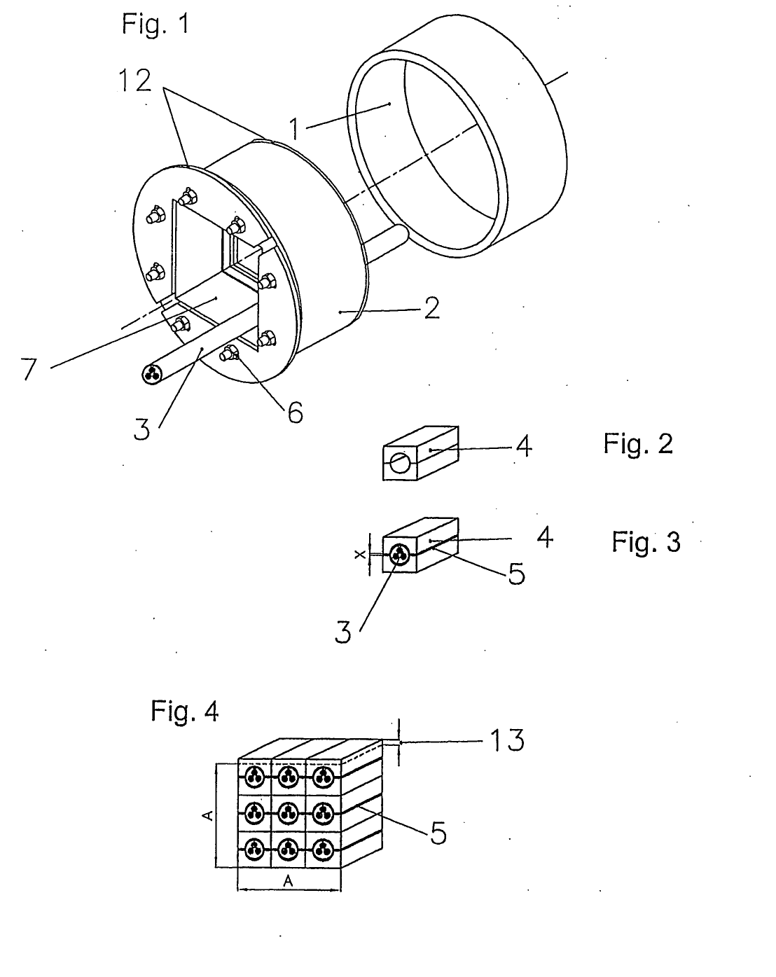

FIG. 1 is a diagrammatic representation of a usual device having frame, sealing body and provided cable;

FIG. 2 shows a module for insertion as splitted fitting piece;

FIG. 3 is a representation corresponding to FIG. 2 with inserted cable;

FIG. 4 shows a number of modules, in the way as they are arranged for insertion in the pack accommodation of the sealing body;

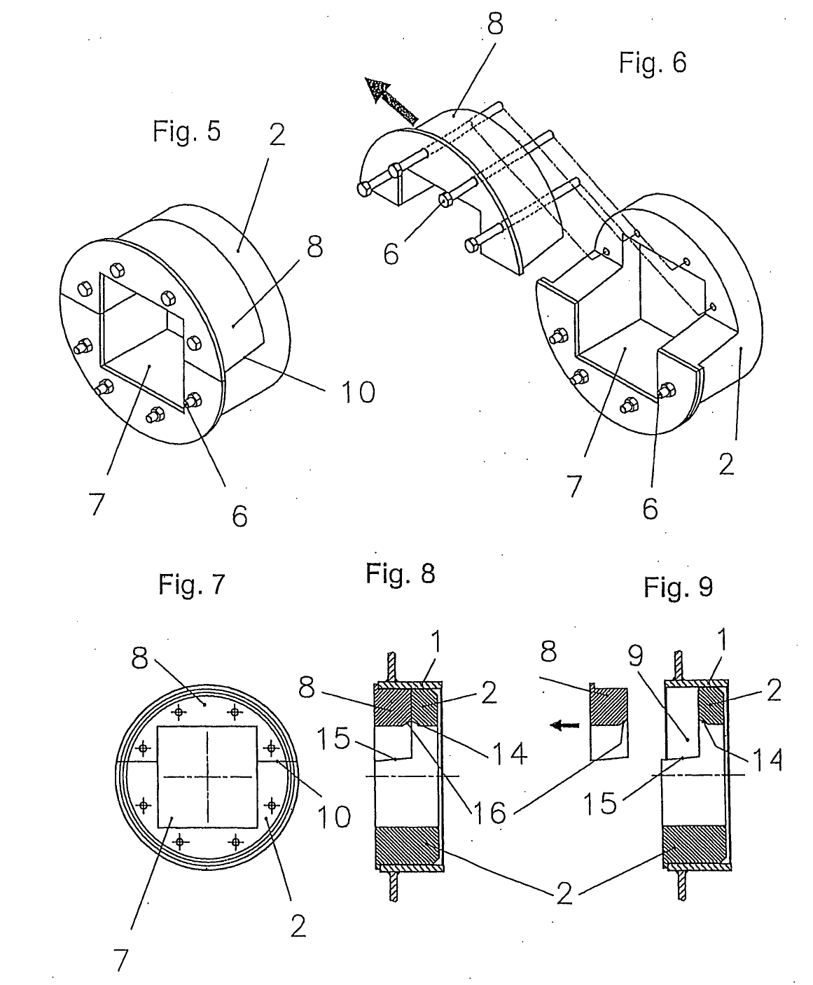

FIG. 5 is a perspective representation of a sealing body with inserted part element;

FIG. 6 is a representation, corresponding to FIG. 5, with a separated sealing body;

FIG. 7 is a plan view of a sealing body without pressure plates and screws;

FIGS. 8 and 9 is a cross-section according to FIG. 7 with provided and inserted part element;

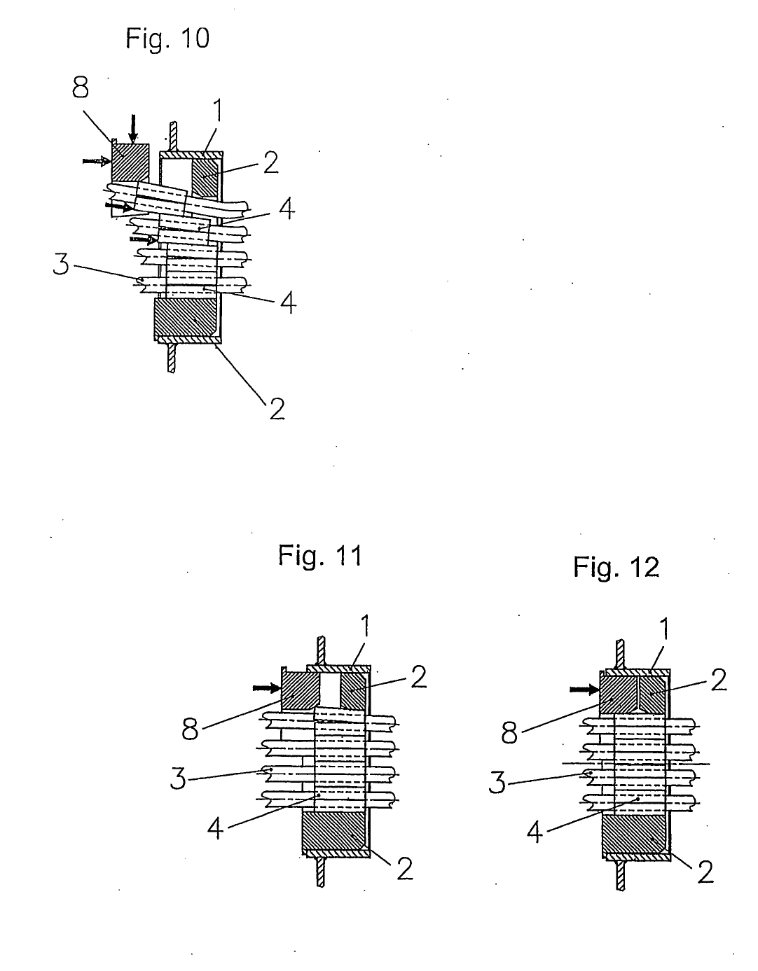

FIG. 10 is a diagrammatic representation in the assembly phase of the modules and the provided part element;

FIG. 11 is a representation, corresponding to FIG. 10, at the end assembly of the part element; and

FIG. 12 is an assembled device.

In the device a frame 1 is arranged, which is placed fixed in a not shown wall. This frame 1 receives a corresponding plug formed sealing body 2 of elastic material, which has a central quadratic pack accommodation 7 and which serves as accommodation for modular arranged insertion modules 4 as splitted fitting pieces for cables 3 to be lead through.

The sealing body 2 has pressure plates 12 arranged on both sides, which by means of screws 6 as clamping elements diminish the cross-sectional area of the pack accommodation 7 and also compress the inserted modules 4, in order to achieve tightness with the inserted cables 3 against fire, water and gas.

The choice of modules 4 is done depending on the diameter of the cables 3, in such a way that there will be an air gap 5 between the module halves of the modules 4 before the clamping. If several layers of modules 4 are formed inside the quadratic pack accommodation 7, the separate air gapes 5 with the measurement x will then be summarized to a sum 13 of several millimetres and increase the normal dimension A. This leads to that the assembly of the last row of modules only is possible under complicated conditions.

Therefore it is so arranged, that to increase the pack accommodation 7 a free space 9 is arranged above one of the above each other arranged air gaps 5 as parting lines of the modules 4. For this the sealing body 2 is supplemented by a detachable part element 8, which is formed as segment of a part of the depth of the sealing body 2. This part element 8 is again provided at the sealing body 2 by means of the screws 6 at the assembly.

Through this feature it is possible to increase the assembly space in the sealing body 2, whereby by means of the part element 8 to be inserted the enlargement can be closed again after assembly. Thereafter a clamping of the lead-through is possible in a known way.

In this case the partition line 10 between sealing body 2 and part element 8 is formed as a gradient 15 in the insertion direction.

Furthermore, the boundary edge in the fixed part of the sealing body 2 is furnished with a bevelling 14 to facilitate assembly of the modules 4.

Also the part element 4 is furnished with a bevelling 16 in the end region of the boundary surface for the pack accommodation 7 to facilitate assembly.

1. A device for sealing of inserted cables, conduits or pipes in a wall or roof, the device comprising:
a frame insertable in the wall or roof;
a plug formed sealing body sealingly fitted into the frame, the sealing body forming a quadrangular accommodation area;
at least one module arranged in the accommodating area, the at least one module being a split fitting piece that received one of the cables, conduits or pipes; wherein the sealing body includes a fixed part and a separate part element that forms at least one boundary surface of the accommodating area for at least one module and forms a free space for insertion of the at least one module and is positionable in the sealing body for end assembly by claiming elements.

2. The device of claim 1, wherein the separate part element of the sealing body is formed above or under parting lines of the modules.

3. The device of claim 1, wherein the separate part element has about 60% of the depth of the sealing body.

4. The device of claim 1, wherein an end region of a boundary surface of the pack accommodation area and the separate part element has a bevelling in an insert direction of the modules.

5. The device claim 1, wherein the fixed part of the sealing body corresponding with the separate part element has a bevelling in the insertion direction of the modules.

6. The device claim 1, wherein a horizontal partition line between sealing body and the separate part element has a gradient in an insertion direction of the separate part element.

7. The device of claim 1, wherein the sealing body is comprised of an elastic material.

8. The device of claim 1, wherein the at least one module has a square form and is one of wholly or partially elastic.

9. The device of claim 1, wherein a plurality of modules are arranged adjacent to one another in the accommodating area.

10. The device of claim 1, wherein the sealing body includes at least one of pressure elements and displaceable clamping elements.
